(19) United States
(12) Patent Application Publication
(10) Pub. No.: US 2009/0189765 A1
(43) Pub. Date: Jul. 30, 2009

(54) Security apparatus for an electronic device

(76) Inventors: Jeffrey A. Lev, Tomball, TX (US); Paul J. Doczy, Cypress, TX (US); Jeffrey C. Parker, Magnolia, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/011,722

(22) Filed: Jan. 29, 2008

(51) Int. Cl. G08B 13/14; E05B 65/00

(52) U.S. Cl. 340/568.2; 70/57.1; 70/57; 340/568.1; 340/572.1

(57) ABSTRACT

An apparatus is provided for deterring theft of an electronic device. The apparatus comprises of a retaining member comprising a locking mechanism attached at a first end of the retaining member and an anchoring mechanism at a second end of the retaining member; and a coupling connector protruding from the retaining member for coupling a data port of the electronic device

### BACKGROUND

Electronic devices of all types are subject to theft. Protecting electronic devices is essential due to the expense associated with replacing them. Equally important, if not more important, is the need to protect any confidential information stored on the electronic device. Due to their portability, portable electronic devices are particularly susceptible to theft. Various anti-theft devices have been proposed to prevent the theft of electronic devices, such as portable personal computers. For example, a locking mechanism may be used to attach an anchored cable to a portable computer to deter theft. However, such security measures may be circumvented by physically cutting the cable.

### BRIEF DESCRIPTION OF THE DRAWINGS

For a more complete understanding of the present application, the objects and advantages thereof, reference is now made to the following descriptions taken in conjunction with the accompanying drawings, in which:

FIG. 1 is a diagram illustrating an embodiment of a security apparatus for an electronic device;

FIG. 2 is a diagram illustrating an embodiment of a coupling connector of the security apparatus of FIG. 1;

FIG. 3 is a diagram illustrating an embodiment of a locking mechanism of the security apparatus of FIG. 1;

FIG. 4 is a diagram illustrating another embodiment of a security for an electronic device;

FIG. 5 is a block diagram illustrating an embodiment of a security apparatus connected to an electronic device; and

FIG. 6 is flow diagram illustrating an embodiment of a process for providing security for an electronic device.

### DETAILED DESCRIPTION OF THE DRAWINGS

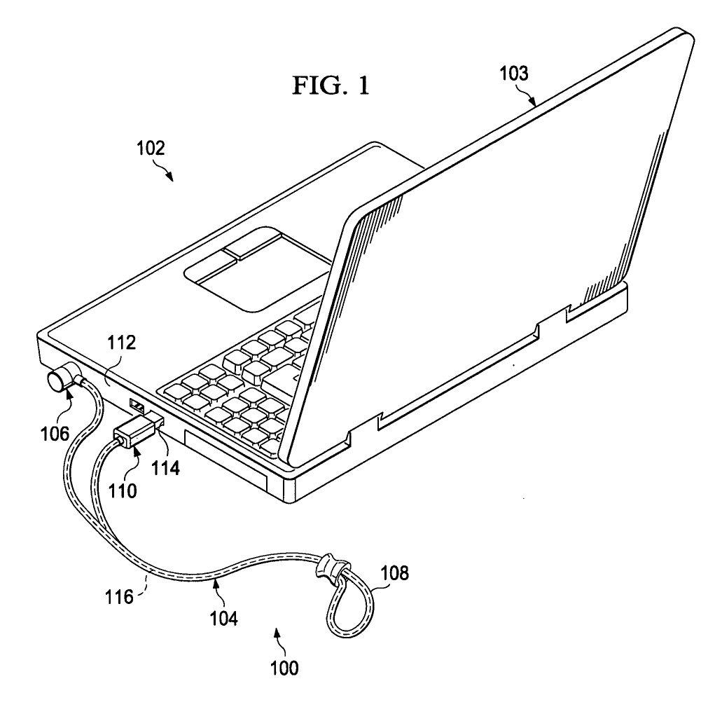

FIG. 1 is a diagram illustrating an embodiment of a security apparatus for an electronic device. Security apparatus 100 is attached to electronic device 102. In FIG. 1, electronic device 102 is depicted as a portable computer 103. However, electronic device 102 may be any type of electronic device including, but not limited to, a desktop computer, a personal digital assistant (PDA), an audio device, an audio device dock, a video device, a gaming device, a printer, a scanner, and a cellular telephone.

Security apparatus 100 includes a retaining member 104 having a locking mechanism 106, an anchor member 108, and a coupling connector 110. Locking mechanism 106 may be removably attached to an enclosure 112 of electronic device 102. Anchor member 108 may be attached to a substantially immovable object such as a desk or wall to deter unauthorized transport of electronic device 102. Coupling connector 110 may be coupled to a data port 114 of electronic device 102.

In the embodiment illustrated in FIG. 1, coupling connector 110 is implemented as a universal serial bus (USB) device. However, it should be understood that coupling connector 110 may be implemented with any type of connector including, but not limited to, connectors compatible with a serial port, a parallel port, a PS/2 port, and a FireWire port.

In some embodiments, security apparatus 100 may include an embedded electrical wire 116 extending at least partially from the coupling connector 110 to anchor member 108. Embedded electrical wire 116 may transmit an electrical signal through coupling connector 110. The electrical signal is generated using power provided by electronic device 102. During a time when electronic device 102 is powered off, the signal may still be generated using power supplied by a keyboard controller or other internal components of electronic device 102. A portion of the keyboard controller may be awake for handling input received from the computer keyboard.

Data port 114 may be configured with a general purpose input/output (GPIO) controller communicatively coupled to a component of electronic device 102 such as a basic input/output system (BIOS), to monitor for the presence of the electrical signal transmitted along embedded electrical wire 116. Electronic device 102 may be configured to perform a predetermined security measure in response to detecting the absence of the electrical signal such as, but not limited to, when security apparatus 100 is severed. Data port 114 may also be configured to monitor for the presence of coupling connector 110 and to perform a set of predetermined security measures in response to detecting the absence of coupling connector 110.

The predetermined security measures may include, but are not limited to, an alarm, a system lock-out, and a remote notification procedure. The alarm may be an audible alarm played through the speakers of electronic device 102. The system lock-out may include, but is not limited to, a password lock, a data encryption process, and/or disabling powering-on of electronic device 102. In addition, the remote notification procedure may include notifying security personnel, information technology personnel, and/or the owner of electronic device 102.

In some embodiments, coupling connector 110 may also include more advanced electronic characteristics. For example, coupling connector 110 may have resistors to create specific signals to the BIOS in order for the BIOS to detect “open” or “short” conditions. Coupling connector 110 may also contain electronic cryptographic keys such as, but not limited to, those used by smart card systems. Electronic device 102 may use the cryptographic keys to enable hard drive operation and/or to authenticate the security system. Without the cryptographic keys, electronic device 102 may be rendered useless by, but not limited to, preventing booting, locking drive operation, and/or disabling drive encryption.

Further, in some embodiments, locking mechanism 106 may be configured to enable or disable the security features provided by security apparatus 100 upon proper locking and unlocking of locking mechanism 106. For example, this feature may be performed via simple voltage or current detection by the BIOS through a general purpose input/output (GPIO) controller.

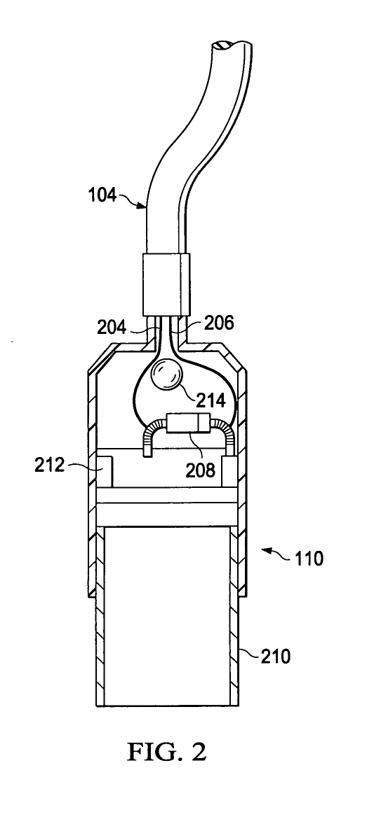

FIG. 2 is a diagram illustrating an embodiment of coupling connector 110. In the embodiment illustrated in FIG. 2, coupling connector 110 is illustrated as a universal serial bus (USB) device type. Coupling connector 110 is connected to retaining member 104. Retaining member 104 comprises of wires 204 and 206. Retaining member 104 may also comprise of other twisted strands of metal. Wires 204 and 206 are connected to diode 208. Diode 208 is connected to data and ground terminals of contact 210, through a jack 212. Contact 210 connects to electronic device electronic device 102 through data port 114 (FIG. 1). A current runs through wires 204 and 206 in such polarity that it does not flow through diode 208, but instead flows into electronic device 102. A return signal is detected by electronic device 102, indicating the presence of coupling connector 110 and a light-emitting diode (LED) 214 is illuminated. If retaining member 104 is severed, or if coupling connector 110 is disconnected from electronic device 102, electronic device 102 detects the absence of a return signal and a predetermined security measure is initiated.

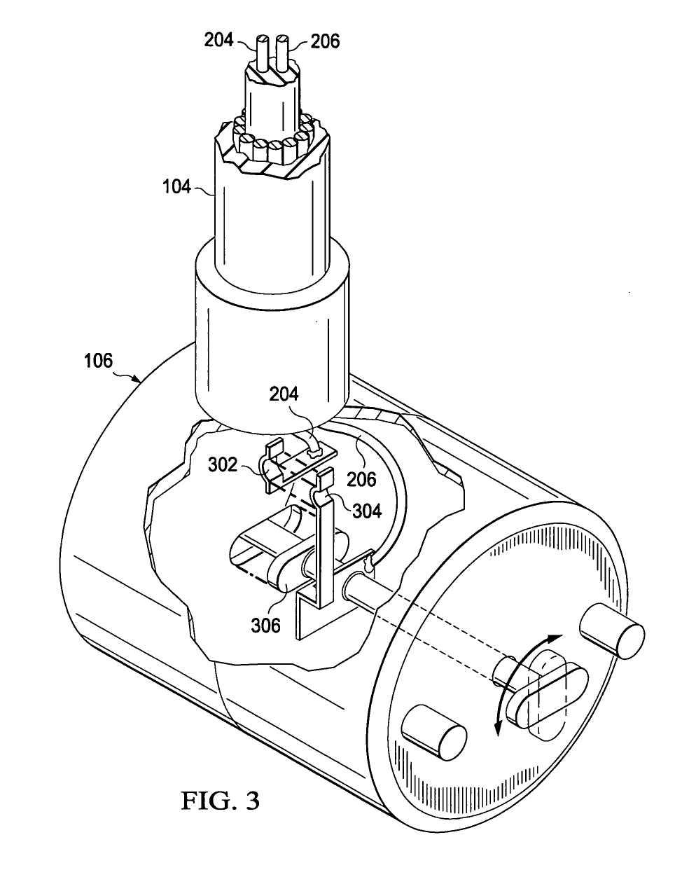

FIG. 3 is a diagram illustrating an embodiment of locking mechanism 106. In the embodiment illustrated in FIG. 3, locking mechanism 106 is connected to retaining member 104 comprising of wires 204 and 206 (FIGS. 1 and 2). A current is initiated from coupling connector 110 through wires 204 and 206. For example, upon connecting coupling connector 110 to electronic device 102, a current is generated and transmitted through wire 204. Wire 204 extends at least partially from coupling connector 110 to anchor member 108, as shown in FIG. 1, along retaining member 104. Wire 204 is routed through locking mechanism 106 to contact terminal 302. Wire 206 is routed from coupling connector 110 through locking mechanism 106 to contact terminal 304. Contact terminals 302 and 304 are electrically isolated from each other with respect to electrical continuity. Upon properly locking locking mechanism 106, electrical continuity may be established by physically rotating mechanism 306 within locking mechanism 106 to provide an electrical contact between contact terminals 302 and 304. The current passes from contact terminal 302 to contact terminal 304 and returns to coupling connector. 110 through wire 206. The return signal is detected by electronic device 102, indicating the presence of coupling connector 110. If retaining member 104 is cut, or if coupling connector 110 is disconnected from electronic device 102, electronic device 102 detects the absence of a return signal and a predetermined security measure is initiated.

In some embodiments, properly unlocking locking mechanism 106 disables the predetermined security measures. This may be performed via a mechanism within locking mechanism 106 that sends a simple voltage or current that is detected by the BIOS through a general purpose input/output (GPIO) controller. Upon receiving the voltage or current the BIOS disables the predetermined security measures.

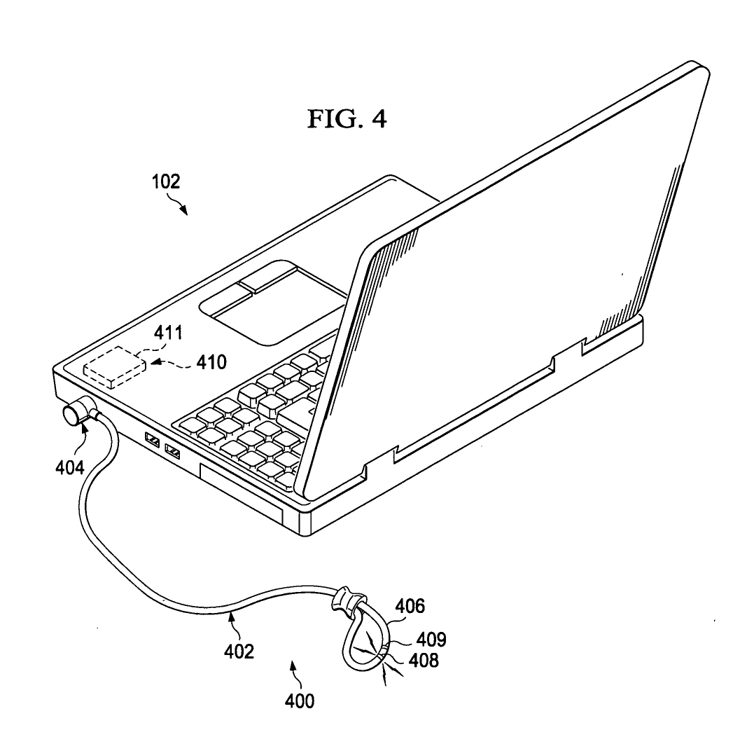

FIG. 4 is a diagram illustrating another embodiment of a security apparatus 400 for electronic device 102. Security apparatus 400 comprises of a retaining member 402 including a locking mechanism 404 for attaching retaining member 402 to electronic device 102. Security apparatus 400 further comprises an anchoring mechanism 406 for attaching retaining member 402 to a substantially immovable object. Retaining member 402 is coupled to a wireless data transmission device 408. In some embodiments, wireless data transmission device 408 is located near anchoring mechanism 406. Wireless data transmission device 408 is configured to communicate with a communication device 410 attached to electronic device 102.

In some embodiments, wireless data transmission device 408 is a radio-frequency identification (RFID) tag. In some embodiments, RFID tag 409 communicates with a RFID tag reader 411 associated with electronic device 102. In some embodiments, RFID tag reader 411 may be configured with a general purpose input/output (GPIO) controller communicatively coupled to a component of electronic device 102, such as the BIOS, to monitor for the presence of an electrical signal transmitted by RFID tag 409. Similar to previous embodiments, electronic device 102 may be configured to perform a predetermined security measure in response to detecting the absence of the electrical signal such as, but not limited to, if security apparatus 400 is severed and electronic device 102 is moved out of the range of the electrical signal transmitted by RFID tag 409. In other embodiments, wireless data transmission device 408 may be a near field communication (NFC) device or other types of wireless communication devices.

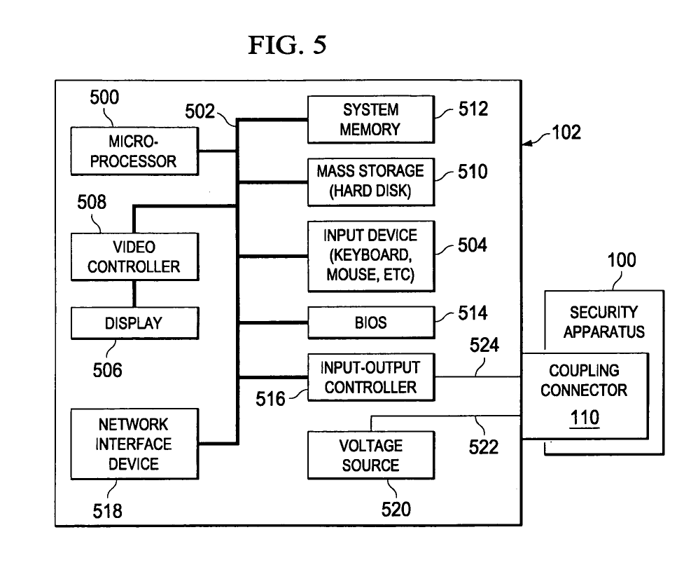

FIG. 5 is a block diagram illustrating an embodiment of security apparatus 100 connected to electronic device 102. Electronic device 102 includes at least one microprocessor 500. Microprocessor 500 is connected to a signal bus signal bus 502. Signal bus 502 serves as a connection between microprocessor 500 and other components of electronic device 102. One or more input devices 504 may be coupled to microprocessor 500 to provide input to microprocessor 500. Examples of input devices include keyboards, touch screens, and pointing devices such as a mouse, a trackball, and a tack pad. Electronic device 102 may also include a display 506 which is typically coupled to microprocessor 500 by a video controller 508. Programs and data are stored on a mass storage device 510 which is coupled to microprocessor 500. Mass storage devices include components such as hard disks, optical disks, magneto-optical drives, and floppy drives. A system memory 512 is coupled to microprocessor 500 for providing microprocessor 500 with fast storage to facilitate execution of computer programs by microprocessor 500. A basic input/output system (BIOS) 514 and an input/output controller 516 are also coupled to signal bus signal bus 502 for communicating with each other and with microprocessor 500. It should be understood that other busses and intermediate circuits can be employed between the components described above and microprocessor 500 to facilitate interconnection between the components and microprocessor 500.

Still referring to FIG. 5, in one embodiment, BIOS 514 is communicatively coupled to input/output controller 516 and a reference voltage source reference voltage source 520. Coupling connector 110 of security apparatus 100, as shown in FIG. 1, is also communicatively coupled between input/output controller 516 and reference voltage source 520. Reference voltage source 520 is maintained at a first reference voltage. A signal line 522 is connected to a general purpose input/output (GPIO) signal line 524 of input/output controller 516. GPIO signal line 524 is maintained at a second reference voltage when not connected to security apparatus 100. GPIO signal line 524 is maintained at the first reference voltage when signal line 522 is connected between GPIO signal line 524 and reference voltage source 520. When coupling connector 110 is removed from a data port of electronic device 102 or when continuity of the signal is broken, such as by severing retaining member 104, as shown in FIG. 1, the voltage of GPIO signal line 524 changes from the first reference voltage to the second reference voltage. When GPIO signal line 524 is polled by BIOS 514, BIOS 514 may initiate one or more security measures in response to detecting the absence of coupling connector 110 or the break in continuity of the electrical signal. These security measures include activating an alarm, sending a message to a system administrator through a network interface device 518 and/or disabling all or part of the functionality of electronic device 102.

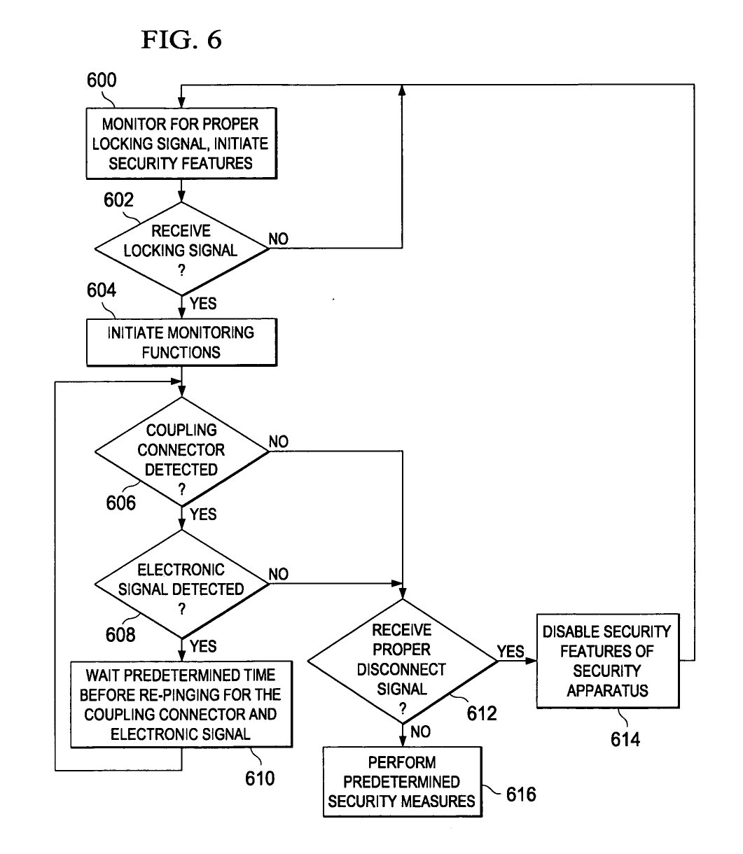

FIG. 6 is flow diagram illustrating an embodiment of a process for providing security for an electronic device. The process of FIG. 6 may be implemented in a microprocessor of an electronic device, such as microprocessor 500 shown in FIG. 5.

The process begins by monitoring for a proper locking signal to initiate the security features of security apparatus 100 at block 600. The process determines if a locking signal is received at block 602. If a proper locking signal has not been received, the process returns to block 600 to continue monitoring for a proper locking signal. If a proper locking signal is received, the process initiates the monitoring function of security apparatus 100 at block 604. At block 606, the process determines if coupling connector 110 of security apparatus 100 is detected. At block 608, the process determines if an electrical signal, as described above, is detected. If the process detects both coupling connector 110 and the electrical signal, the process will wait a predetermined amount of time before re-pinging for the presence of coupling connector 110 and the electrical signal.

However, if at either block 606 or 608, coupling connector 110 or the electrical signal is not detected, the process determines if a proper disconnect signal has been received at block 612. Responsive to receiving a proper disconnect signal, at block 612, the process disables the security features of security apparatus 100. The process then returns to block 600 to continue monitoring for a proper locking signal.

However, if at block 612, the process has not received a proper disconnect signal, the process performs a set of predetermined security measures. The predetermined security measures may include, but are not limited to, an alarm, a system lock-out, and a remote notification procedure. A similar process may be initiated for detecting the presence of an RFID signal or an NFC signal in accordance with other illustrative embodiments. It should also be understood that the illustrative embodiments may combine, omit, and/or add additional blocks to FIG. 6 to enable the security features of security apparatus 100.

Accordingly, the illustrating embodiments provide a security apparatus 100 that provides both a physical protection mechanism and an extra level of security provided through a coupling connector 110 attached to an electronic device 102. Security apparatus 100 is configured to enable a set of predetermined security measures to be performed by electronic device 102 in response to detecting the removal or severance of security apparatus 100. In addition to deterring the theft of electronic device 102, the illustrative embodiments provide additional security for the data stored on electronic device 102 through means of, but not limited to, encrypting the data, password lock-out, and/or initiating a system lockout.

What is claimed is:

1. An apparatus for deterring theft of an electronic device, the apparatus comprising:
a retaining member comprising a locking mechanism attached at a first end of the retaining member and an anchoring mechanism at a second end of the retaining member; and
a coupling connector protruding from the retaining member for coupling to a data port of the electronic device.

2. The apparatus of claim 1, further comprising an embedded electrical wire extending at least partially from the coupling connector to the second end of the retaining member.

3. The apparatus of claim 1, wherein the coupling connector is a universal serial bus device.

4. The apparatus of claim 1, wherein the electronic device is configured to monitor for a presence of an electrical signal at the data port from the coupling connector.

5. The apparatus of claim 1, wherein the electronic device is configured to monitor for a presence of the coupling connector connected to the data port.

6. The apparatus of claim 1, wherein the electronic device is configured to perform a security measure in response to detecting an absence of an electrical signal at the data port from the coupling connector.

7. The apparatus of claim 1, wherein locking the locking mechanism enables the electronic device to monitor for an electrical signal at the data port.

8. The apparatus of claim 1, wherein unlocking the locking mechanism disables the electronic device from monitoring for an electrical signal at the data port.

9. The apparatus of claim 1, wherein the electronic device is configured to trigger at least one of an alarm, a system lock-out, and a remote notification procedure in response to detecting an absence of an electrical signal at the data port.

10. The apparatus of claim 1, wherein the electronic device is configured to trigger at least one of an alarm, a system lock-out, and a remote notification procedure in response to detecting disconnection of the coupling connector from the data port.

11. An apparatus for deterring theft of an electronic device, the apparatus comprising:
a retaining member comprising a locking mechanism attached at a first end of the retaining member for attaching the retaining member to the electronic device and attached at a second end to an anchoring mechanism; and
a wireless data transmission device coupled to the cable.

12. The apparatus of claim 11, wherein the wireless data transmission device is a radio-frequency identification tag.

13. The apparatus of claim 11, wherein the wireless data transmission device comprises a radio-frequency identification tag able to communicate with a radio-frequency identification tag reader associated with the electronic device.

14. The apparatus of claim 11, wherein the electronic device is configured to perform a security measure in response to detecting the absence of a signal received from the wireless data transmission device.

15. A computer implemented method for deterring theft of an electronic device, the computer implemented method comprising:
monitoring for a presence of a security device, wherein the security device comprises of a retaining member comprising a locking mechanism for attaching the retaining member to the electronic device, and wherein the retaining member has a coupling connector for coupling to a data port of the electronic device; and
responsive to detecting an absence of the coupling device, implementing a predetermined security measure.

16. The computer implemented method of claim 15, further comprising:
monitoring for a signal transmitted along an embedded electrical wire within the retaining member; and
responsive to detecting an absence of the signal, implementing the predetermined security measure.

17. The computer implemented method of claim 15, wherein the predetermined security measure comprises of at least one of an alarm, a system lock-out, and a remote notification procedure.

18. The computer implemented method of claim 15, wherein monitoring for the presence of the security device is enabled by locking the locking mechanism.

19. A computer implemented method for deterring theft of an electronic device, the computer implemented method comprising:
monitoring for a presence of a security device, wherein the security device comprises a retaining member comprising a locking mechanism attached at a first end of the retaining member for attaching the retaining member to the electronic device and attached at a second end to an anchoring mechanism, and a wireless data transmission device coupled to the retaining member; and
responsive to detecting an absence of a signal generated by the wireless data transmission device, implementing a predetermined security measure.

20. The computer implemented method of claim 19, wherein the wireless data transmission device is a radio-frequency identification tag.
